(19) United States
(12) Patent Application Publication
(10) Pub. No.: US 2013/0018862 A1
(43) Pub. Date: Jan. 17, 2013

(54) Human Filtered Community Based Search and Discovery Engine

(71) Applicant: Jean Alexandera Munemann, London (GB)

(72) Inventor: Jean Alexandera Munemann, London (GB)

(21) Appl. No.: 13/182,397

(22) Filed: Jul. 13, 2011

(51) Int. Cl. G06F 17/30

(52) U.S. Cl. 707/706; 707/794; 707/769; 707/766; 707/E17.108; 707/E17.099

(57) ABSTRACT

It is a search process, which combines human inputted filters, emotional ratings and tags, select criteria and selection, identified and unidentified sources, and negative filters, for a community based Intranet and Internet combined search and discovery engine, and database management system. It works though set user generated communities [families, clubs, organizations etc.] individually, or joining together to identify, rate, and trust their own Intranet information, and then the external Internet content. Through human participation content is catalogued, and prioritized according to group needs. This brings the emphasis on to human judgement for the end search results.

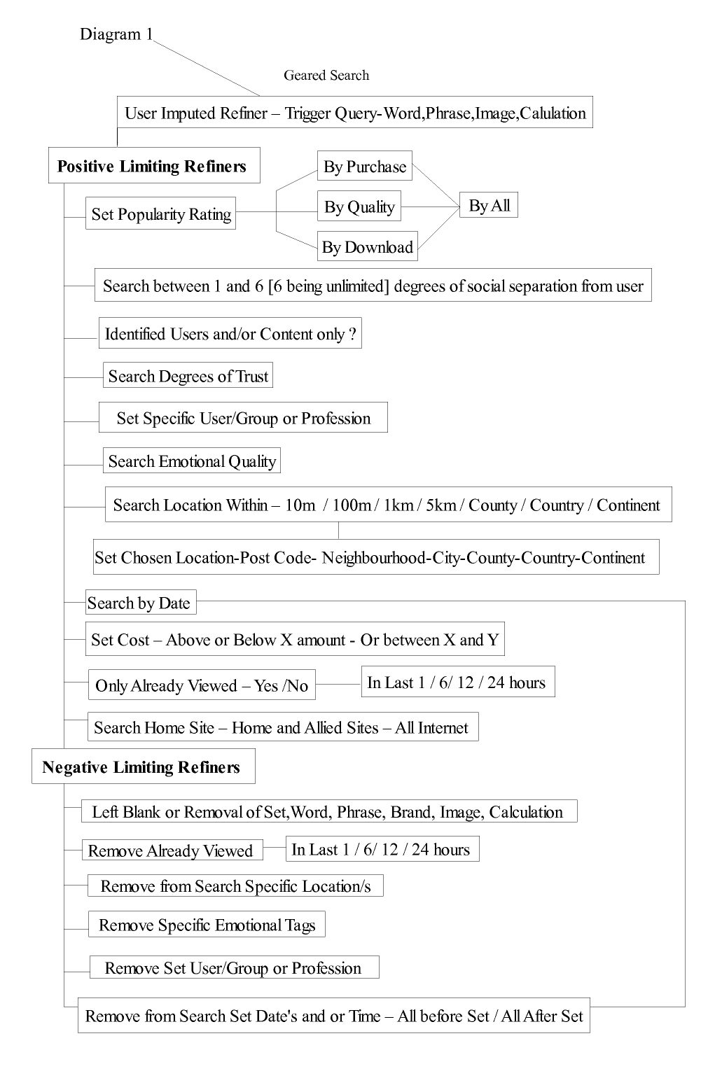

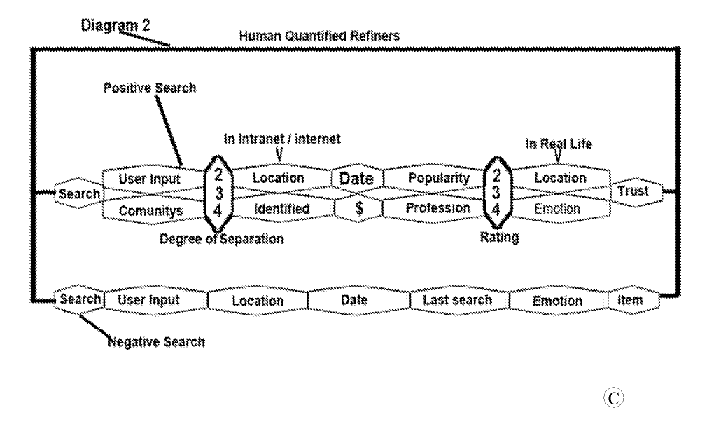

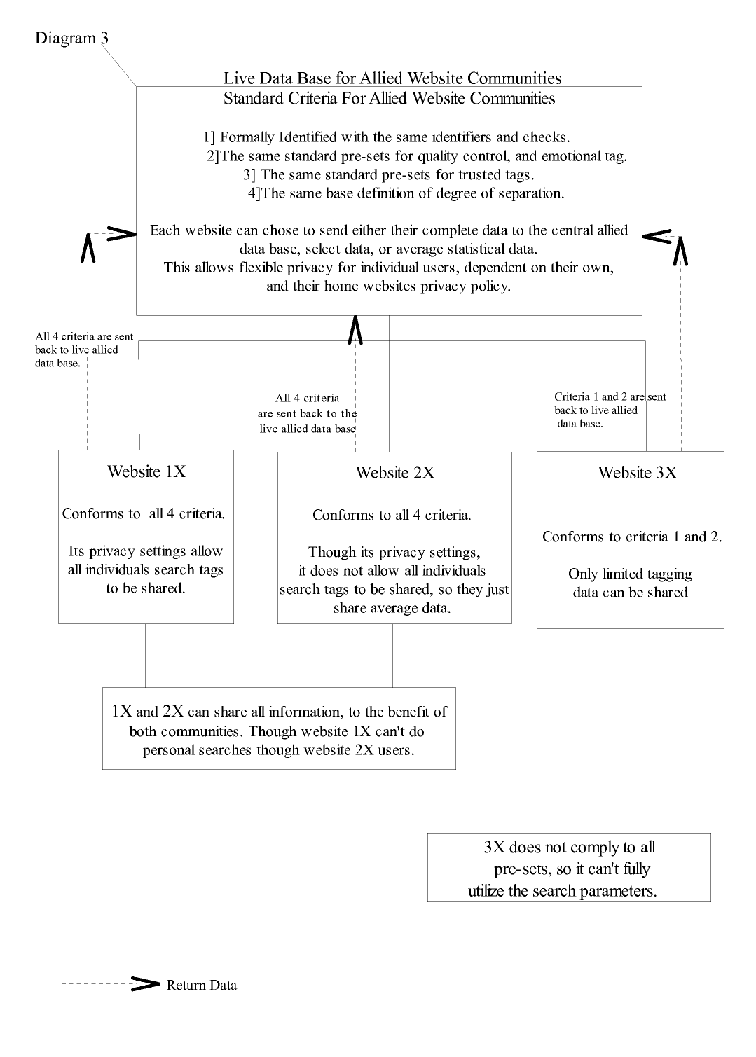

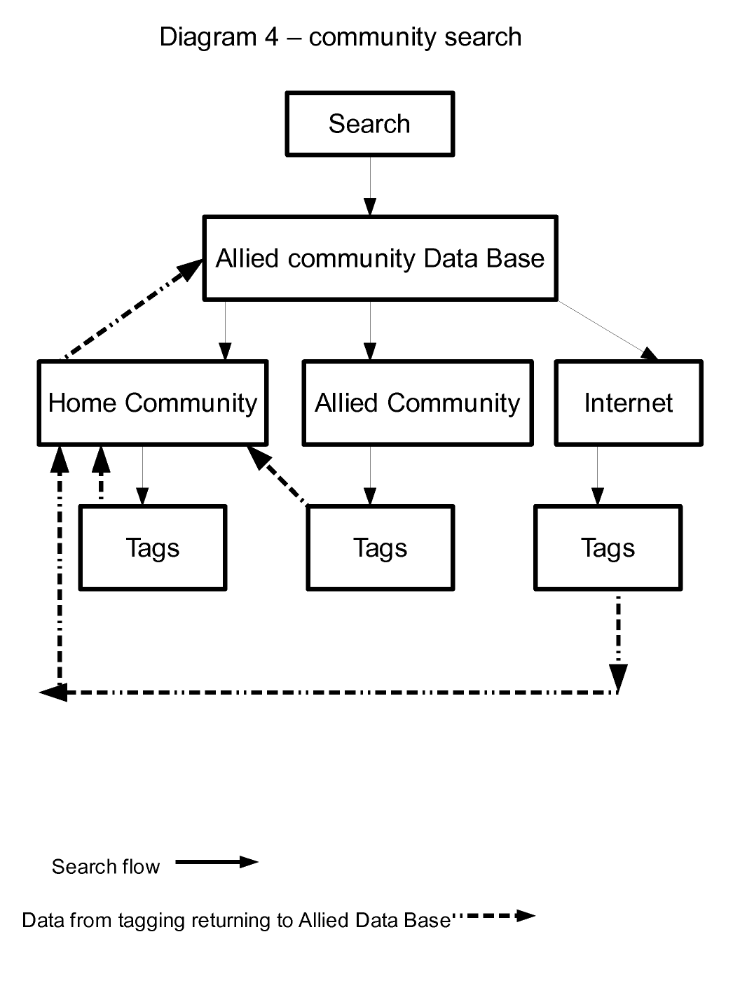

### SUMMARY OF THE INVENTION

This invention relates to a clearly outlined community based search system for an Intranet and the Internet, which aims to increase the quality of search results by human opinion, and refine it further by trust.

We switch the primary filter of search to human connections, and judgement, as this will increase efficiency.

### FIELD OF INVENTION

This invention relates to a search method, which combines human imputed criteria and select refiners, for a community based Intranet and Internet combined search, or discovery engine.

There are many forms of search online, most of which are algorithmically driven. With the ever increasing content, its harder and harder to find A] what you are looking for B] to be able to trust the information received.

I come at this from a philosophical democratic angle, not algorithmic, and I acknowledge the large strides in search made by the brand leaders. I also acknowledge that some patents have been granted touching on human interaction with search and data base management, and that they are trying to humanize the search question.

That said, I am specifically detailing and ordering, which criteria community based search should adhere to for a more secure search, with more accurate results. I believe in the originality of how the specifics interact. I also believe in how this search can aide online and real life communities to help one another, and reward participation with group benefits.

With people interacting with content refiners to differentiate the quality of the content, to have the content linked on publication to identity if so chosen, to have the rater's themselves identified if they wish, to have identity linked to profession, and then all those refiners to trust and emotion, we democratize and humanize the search system, while maintaining privacy.

By creating the trusted, identified interactive community, we work together to make our virtual world as safe as possible.

I've come across many patents and patent applications in my search to see if my process was original enough, I believe most of them are algorithmic, or if human quantified they have tried to be extremely broad and general in scope, and not defining the specifics of the process. I don't want to do that, I am trying to be very specific in my claims, and to create clarity within this defined process.

### BRIEF DESCRIPTION OF THE DRAWINGS

Diagram 1 Shows a possible users journey through the search engine.

Diagram 2 Shows one version of a graphic interface of how to the apply search engine.

Diagram 3 Shows how this search base criteria can be taken across multiple communities.

Diagram 4 Shows how privacy can be achieved via the home community.

### DETAILED DESCRIPTION OF THE INVENTION

Search is about wanting to find something.

You need classifications and refiners to limit the search, and the information that your looking through needs to be tagged with those classifications and refiners to help find something more quickly.

Its about order and simplification of classifications, to help the retrieval of data. This is paramount to a good search process, basically its a filing process, its efficacy is in its structure of data retrieval and organization.

By having human beings and not algorithms tag the information at upload, or when they come across it, the human tagging will be more accurate then a pure algorithm.

With this process, stage by stage, narrowing the search area we are not overwhelmed by superfluous data.

Current search or discovery engines don't fully integrate everything needed to make search results socially relevant, trustworthy, or precise enough to generate the result needed in an information overloaded Internet.

By working through quantified human imputed refiners in the intranet [a specific network, or community], which then expands for total search into the Internet, we get a more accurate result, it is more then a sum of its parts, human judgement makes it so. As multiple communities develop, they can be allies and share their data base's, as long as they share their original set criteria.

By defining the search criteria tightly through human input and tagging of information, including degree of social separation, identity, such as identified or unidentified user/raters, professional or non professional, positive or/and negative refiners [such as removal of past searches], a set quantified positive and negative rating system, location and distance, as well as key word search, and emotional content, we get a more refined result.

What you want to search for?

Where you want to search—Intranet or internet?

Through whom, or who's opinion do you want to search?

What degree of separation do you want to use?

What quality do you want to see?

What physical location if any do you want to search?

What dates do you want?

What emotion do you want ?

What don't you want?

In what order do you want to see the results?

Please view diagram 1

Identification—To be a fully interactive part of the search community, you must be identified. With this form of search which identifies you, and so much of your personality and taste, I believe people must have the option of privacy, with having a community, the community can act as a filter sending average data of their users without personal identifiers to the allied live database, this of course would depend on the community and users privacy settings. If you can't trust a user because you don't know who they are, as they are anonymous, you can trust the reputation of the community/website that is identified.

Unidentified people/communities could make use of the search based on other peoples/communities tagging of data, but if they are not identified they would not be able to tag data as this could bias results.

Please view diagrams 3 and 4

Single Community Search

Please view diagram 2—which shows one possible version of a graphic interface of how to the apply search engine.

Each refiner is a necessary criteria, which gears up to the most accurate result, its how it all works together that makes it original. It rest's on the user to make use of all the criteria, for the most accurate result.

Results of the search are based on any criteria, or all, that the user chooses to input.

### Community and Tagging

Criteria. A.1] Users join together in an online web community.

Criteria. A. 2] Users identify themselves, and are identified by others.

Criteria. A. 3] Users rate other users, by degrees of social separation, and trust.

Criteria. A. 4] Users rate their own and community/Intranet content using a variety of options, positive and negative rating on content, usability, suitability [such as age sensitive rating], identity, professional knowledge, trust, emotion of content, brand, relevance and others, depending on the item or page. The users feedback is then added to their search criteria, and the communities database.

Criteria. A. 5] Users rate allied communities and the Internet content using a variety of options, positive and negative rating on content, usability, suitability [such as age sensitive rating], identity, professional knowledge, trust, emotion of content, brand, relevance and others, depending on the item or page. The users feedback is then added to their search criteria, and the communities database.

### Search

Criteria. B. 1] User imputes their search, word, phrase, or image.

Criteria. B. 2] User quantifies limit to search location—Intranet, intranet and allied communities, or all the Internet.

Criteria. B. 3] User quantifies a limit to their search if any, by degree of specific social separation, by community, particular person, profession, or group.

Criteria. B. 4] User quantifies limit the search by level of trust, and/or identified content, and or professional content.

Criteria. B. 5] User quantifies limit if any, to search by physical location.

Criteria. B. 6] User quantifies if any, limit to search by specific date and time—such as between [dd/mm/yy] 13 Aug. 2010 to 21 Aug. 2010.

Criteria. B. 7] User quantifies limit if any, to search by cost of item/s.

Criteria. B. 8] User quantifies limit to search by differing versions of popularity.

Criteria. B. 9] User quantifies limit to search by personal viewing history.

Criteria. B. 10] User quantifies emotional state of content if required.

Criteria. B. 11] User quantifies limit to search by suitability [such as age sensitive rating].

### Negative Search Refiners—

Criteria. C.1] User specifies to remove from search, word, phrase, or image.

Criteria. C.2] User specifies to remove from search, set physical location.

Criteria. C.3] User specifies to remove from search, specific date or time.

Criteria. C.4] User specifies to remove from search by personal viewing history.

Criteria. C.5] User specifies to remove from search, person, group or profession.

Criteria. C.6] User specifies to remove from search, type of emotion [such as scary/sad etc].

Criteria. C.7] User specifies to remove from search, specific brand, or item.

Criteria. C.8] User specifies to remove from search, select suitability rating [such as age sensitive rating].

### Further Elaboration—

With the mix of Criteria .B.6] and Criteria .C.3] you get a specific time frame, such as between [dd/mm/yy] positive search 13 August 10 to 21 August 10 but not 19 August 10.

### Multiple Community Cooperative Search, Personal and Community Privacy.

Please view Diagram 4 which shows how privacy can be achieved via the home community and group allied data base.

Communities can join together and share their database's of tag's and identifiers, by sharing their data bases, if they chose they can keep their users anonymous.

The users tagging and identity data is sent back to the home communities live data base, via a graphic interface that is attached to the users browser. The users pre-set privacy settings, filter what is sent to the data base from their private account. The home communities data filtered by their privacy settings, is then sent to the allied community data base.

The issue of trust falls on the home community, not the individual, this allows the user privacy within the Internet.

### A Possible User Journey

1.“Anna” a nurse joins community “XYZ online” a popular social website where she lives. She identifies herself by her choice of identifiers—such as a credit card, bank details, drivers licence, passport, national identity card/number etcetera, she also states she is a professional nurse. When she joins “Anna” acknowledges people she knows in the community personally, and is acknowledged by the people she knows. The people who personally know “Anna” agree she is who she says, and that she is a professional nurse. Anna is also rated by some people by trust, the more who trust her the greater her Marked community standing.

From this point “Anna” is a trusted part of the “XYZ online” community, and when she is navigating “XYZ”, she can rate and tag at will, by emotion, quality, etc. She also acknowledges and trusts people, and/or content. This becomes part of the community data base, and when she is on the Internet, she also rates and trusts organizations, other community's, pages, people and other content. People who trust “Anna” and her taste can put her in their own particular “search group”.

“Anna” has just moved to a new town for her job, some of her work mates are part of “XYZ”, though most are part of “OMP” a sister community much more popular in her new town. Anna's car wont start one morning, she uses “XYZ” as her interface to search for a mechanic, she inputs for her search; —mechanic—professional—3 degrees of separation—above a 3 star quality rating—within 20 miles from her current location-trusted by over 10 identified people—member of “XYZ” or an allied community [like OMP].

By searching for a mechanic using this combination Anna does not have to send “help” texts or calls, she does not have to search using an alternate search method which would bring possibly a worse mechanic with better online advertising.

She gets what she's asked—a choice of local, good quality, trusted, professional mechanic-s quickly, and from trusted identified sources such as recommended by friends, or known people.

Anna chooses “Bob” who has the best “Friendly” emotional tags, and fits her other criteria.

2.“Anna” wants to re read a magazine article she remembered she read over 3 months ago, but it may have been a bit more, maybe even 6 months ago. By using the positive and negative time filters B.6 and C.3 she can get a specific time frame to search, this shortens her search results considerably.

3.“Anna” is on a road trip, she wants to get a bite to eat, she inputs “restaurant”, recommended by trusted individuals within XYZ and allied communities, within 10 km of her current location [criteria B.6] and negative search refiner—removal of dangerous[criteria C.2], and scary locations [criteria C.6].

4.“Anna” is buying a new computer, her last computer brand “RinT” had awful problems and the customer support was appalling, she does not want to buy that brand again. Anna is trying to discover which brand has the best value for money, with decent customer service. She searches “notebook reviews” and “best rated” on her home website XYZ and the allied communities to see what what comes up, using the negative filter criteria 0.7 to remove “RinT” from the search results.

Anyone who uploaded a product description in the home/allied communities, or wrote a review, or tagged the review or product with “RinT” would do so in the knowledge, that on a negative search those labelled would be removed. As that is the case “Rint” should only be tagged if it is the main product in discussion.

1. A live database system, based around different communities of databases that form an ontology, to promote a specific search, based on agreed upon community filters.

2. Dependent on claim 1; A search and discovery engine based on changeable set locations, based on psychical location or a user imputed location, as positive or negative depending on the user imputes.

3. Dependent on claim 1, A search and discovery engine which removes a combination of negative content prior to presentation to searcher, negative to be defined by the users input.

4. A search and discovery engine which has the negative filter of removal of already seen results. cm 5. A search and discovery engine which has the negative filter of removal of a specific location. cm 6. A search and discovery engine using as a filter a specific community, and/or group, and/or profession, and/or an individuals user ratings, and/or emotional tagging. cm 7. A search and discovery engine based on degree of separation which is the social distance between searcher and human based result or rating or recommendation, the arch prioritizing those closest to the searcher, being six degrees of separation, zero being the searcher, six being anyone world wide.

8. A combined positive and negative search, to give the result of specific selected time frames of a set date and time.

9. A search, using as a filter identified people only, or set professionals, or communities, and excluding other individuals, professionals or communities at users prompt.

10. Within the Intranet and Internet, exclude from search results by user prompt, specific brands, items, specification, the exclusion being identified from the description and/or identifiers set by the up loader, search user, or tagged by the community.

11. A search and discovery engine based tagged emotions attached to content by user or community, in the community Intranet, or on the Internet.

12. A live database CRC between multiple ontology's that share a directed semantic network, the ontology's sharing the same base identifiers for individuals, the same base group identifiers, and the same base tagging definitions, enabling shared data to aid search of Intranet and Internet.

13. Dependant on claim 12 enabling privacy of individuals in chosen ontology's by taking average rating of defined user groups without personal identifiers.

14. A search based on emotional content, which has been identified by human tagging.

15. A live database CRC between ontology's that share a directed semantic network, with specific search and discovery methods, based on the combination of; the identified individuals and/or community rating groups, trust, and identity system, which is a combination of user or community imputed identifiers and refiners, the search to comprise of the following: a key word, phrase or image; the users choice of a degree of separation and or trust, degree of separation defined as the social distance between searcher and human based result, one being first degree which is directly known by the user, going up to sixth degree being anyone in the world; possible search through identified or unidentified people, and/or groups, and/or professions only, and/or all; to use the pre-set settings or ratings of a certain individual or group/s as quantifiers for the search; time and date as a positive, neutral, or negative; user and/or community/s rating of relevance, quality or popularity; cost of item set as neutral, highest, lowest or by set amount; changeable set locations by user imputed refiners such as distance from present location and or set area, city, country or and postcode as positive, neutral or negative; search refined by emotional tagging; and negative refiners which can be set at neutral, such as removal of already seen results, removal of a specific person, profession, or groups rating, removal of set location, removal of set brand of item, removal of set item, removal of group of items, removal of set words.

16. A community, human quantified, geared, search and discovery method, based on the combination of; the identified individuals and/or community rating groups, trust, and identity system, which is a combination of user or community imputed identifiers and refiners, the search to comprise of the following: a key word, phrase or image; the users choice of a degree of separation and or trust, degree of separation defined as the social distance between searcher and human based result, one being first degree which is directly known by the user, going up to sixth degree being anyone in the world; possible search through identified or unidentified people, and/or groups, and/or professions only, and/or all; to use the pre-set settings or ratings of a certain individual or group/s as quantifiers for the search; time and date as a positive, neutral, or negative; user and/or community/s rating of relevance, quality or popularity; cost of item set as neutral, highest, lowest or by set amount; changeable set locations by user imputed refiners such as distance from present location and or set area, city, country or and postcode as positive, neutral or negative; search refined by emotional tagging; and negative refiners which can be set at neutral, such as removal of already seen results, removal of a specific person, profession, or groups rating, removal of set location, removal of set brand of item, removal of set item, removal of group of items, removal of set words.
